(19) United States
(12) Patent Application Publication
(10) Pub. No.: US 2026/0108957 A1
(43) Pub. Date: Apr. 23, 2026

(54) Kit For Assembling Objects

(71) Applicant: MONTA LÁ SERVIÇOS DE INTERMEDIAÇÃO LTDA, São Paulo (BR)

(72) Inventor: Luiz CAMARA LOPES FERREIRA, Regensburg (DE)

(21) Appl. No.: 19/117,063

(22) PCT Filed: Sep. 30, 2022
(86) PCT No.: PCT/BR2023/050329

§ 371 Date: Mar. 30, 2025

(30) Foreign Application Priority Data
Sep. 30, 2022 (BR) 2020220199227

(51) Int. Cl. B23B 47/28

(52) U.S. Cl. CPC B23B 47/28

(57) ABSTRACT

A kit (10) for assembling objects is described consisting of a hollow body (11) provided with caps, the kit (10) for assembling objects comprising at least one construction and assembly plan (13) inserted in the hollow body (11), said construction and assembly plan (13) being provided with a plurality of sheets (131) to be positioned on surfaces of a plurality of predefined parts (17) of at least one object (100), the plurality of sheets (131) comprising information, markings and specifics of assembly of at least one object (100), the caps consisting of at least one drilling template (12) fitted into a first end (121) of the hollow body (11) and at least one base template (14) fitted into a second end (122) of the hollow body (11), enclosing at least one construction and assembly plan (13) in the hollow body (11), the drilling template (12) and the base template (14) cooperating with one another and with at least one construction and assembly plan (13) for the assembly of at least one object (100).

### FIELD OF THE DISCLOSURE

The invention relates to an object assembly kit that enables users to independently drill and assemble objects like furniture. It consists of a hollow body containing assembly plans with precise drilling templates that guide users through accurate hole placement, allowing them to select their own materials while achieving professional-quality results without specialized tools or skills.

### BACKGROUND OF THE INVENTION

Parts, such as wooden plates, and fastening elements, such as screws and bolts, are known in the prior art, sold in the form of kits or sets that enable a common person to purchase and assemble a simple piece of furniture.

In these cases, the wooden plates that make up the kit or set, usually MDF type plates, are already cut and drilled in the precise locations during the manufacturing process, leaving the user to simply fix them using screws and/or bolts that are also included in the kit or set. Therefore, the user only needs to follow the assembly diagram and attach one part to another using the fastening elements in the holes already provided and indicated.

These kits are also known as ready-to-assemble furniture or furniture in kits and are common among consumers who want to save money on product delivery and/or assembly service.

In document US 2020008574, an example of this type of kit is described, which consists of a set of ready-to-assemble drawers, comprising parts already containing the necessary holes in the correct places. The user only needs to follow the assembly diagram for connecting the pieces and use the fixing and connecting elements in the holes already made and indicated.

Document EP3248507 refers to a furniture assembly kit, in which a connecting element is provided with the purpose of facilitating the assembly of the furniture in question. Also in this case, the parts of the furniture are available ready-made and drilled to be joined by the user according to an assembly diagram and using the connection elements in question.

It can be seen, therefore, that furniture assembly kits or sets already known in the state of the art consist of the furniture itself, with its parts already drilled and marked during the kits' manufacturing process, offered disassembled and with the necessary connecting and fixing elements for the user to simply associate or assemble one part with another, without any freedom of creation.

Therefore, already known furniture assembly kits or sets do not allow the user to choose the type of material to be used in the furniture, the types of fastening elements, nor can they perform drillings and markings different from those already carried out on the piece at the factory by the furniture kit manufacturer. Furthermore, the user does not have many furniture options in the form of kits that are currently known, and there are also users who want greater freedom to build their objects but are not professionals and do not have the specialized machinery and tools to do so.

Another known disadvantage of well-known furniture assembly kits or sets is the fact that they require factory processing of the material that makes up the kit or set; that is, they require the provision of wooden boards, cuts, holes, and markings on these plates so that they can form kits or sets to be made available to the end user. All this processing is the responsibility of the manufacturer of the kits or sets who, in this case, need to supply the raw materials and have, in the factory, the labor to produce the cuts, markings, and drillings, leaving the user only to assemble the object. Additionally, this production cost at the beginning of the commercial chain increases in a cascade effect until the kit or set reaches the end user at prices that are sometimes inaccessible.

### SUMMARY OF THE INVENTION

The present invention has as its object an object assembly kit formed by a hollow body equipped with lids. The object assembly kit comprises at least one construction and assembly project inserted in the hollow body. Said construction and assembly project is provided with a plurality of blades to be positioned on surfaces of a plurality of pre-defined parts of at least one object. The plurality of blades comprises information, markings, and assembly specifics of at least one object.

The covers consist of at least one drilling template fitted to a first end of the hollow body and at least one base template fitted to a second end of the hollow body, enclosing at least one construction and assembly project in the hollow body. The drilling template and the base template are cooperative with each other and with at least one construction and assembly project for assembling at least one object.

### BRIEF DESCRIPTION OF THE DRAWINGS

The accompanying drawings, which are incorporated in and constitute a part of this specification, illustrate embodiments of the invention and, together with the description, serve to explain the principles of the invention. The drawings are not necessarily to scale, emphasis instead being placed upon illustrating the principles of the vault-based lottery system for exclusive content distribution. In the drawings:

FIG. 1 is a schematic view of the object assembly kit;

FIGS. 2A to 2D are seen in perspectives of the variations of drilling templates that can make up the object assembly kit;

FIG. 3 is a perspective view of the base template that makes up the object assembly kit;

FIG. 4 is a first perspective view illustrating a drilling template cooperating with a base template;

FIGS. 5A and 5B are perspective views of the junction of a drilling template with a base template that make up the object assembly kit;

FIG. 6 is a schematic view of a slide of a construction and assembly project that makes up the object assembly kit;

FIGS. 7A, 7B, 7C, 7D & 7E illustrate the marking legends present on the slides of the construction and assembly projects that make up the object assembly kit;

FIG. 8 is a photo illustrating the fixation of the plurality of blades of a construction and assembly project on the surfaces of the object's parts;

FIG. 9 is a photo that illustrates a drilling template and a base template assembled and ready to be positioned on the marking for flat drilling;

FIG. 10 is a photo that illustrates a drilling template and a base template assembled and positioned on the blade marking for side drilling;

FIG. 11 is a photo that illustrates the parts of the object containing the blades of the construction and assembly project joined and assembled according to the drilling and assembly project of the object assembly kit;

FIG. 12 is a photo illustrating the final object obtained using the object assembly kit.

### DETAILED DESCRIPTION OF PREFERRED EMBODIMENTS

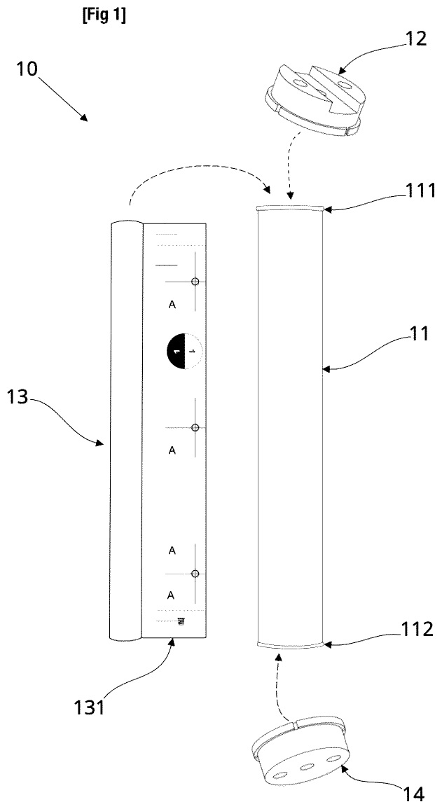

According to a preferred embodiment and as can be seen in FIG. 1, the object assembly kit 10 is formed by a hollow body 11 provided with caps 12 and 14 at its ends and at least one construction and assembly project 13 inserted into the hollow body 11.

Still according to FIG. 1, the covers consist of at least one drilling template 12 fitted to a first end 11 of the hollow body 11 and at least one base template 14 fitted to a second end 12 of the hollow body 11, enclosing at least one construction and assembly project 13 inside the hollow body 11.

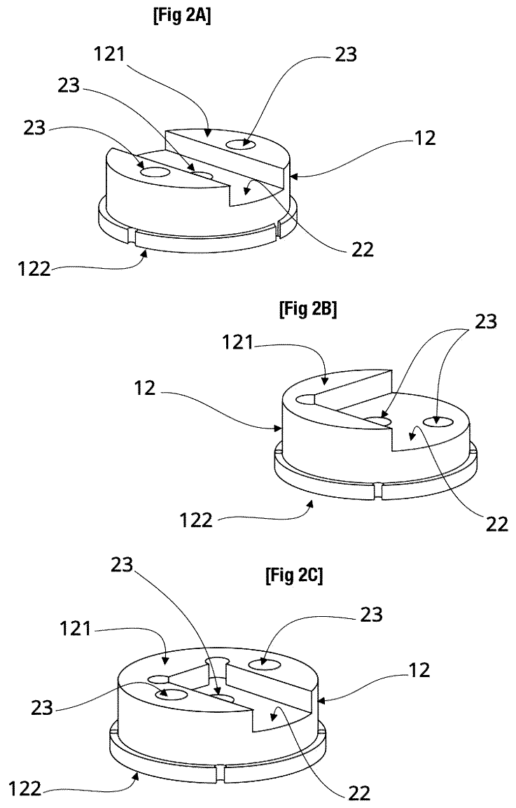

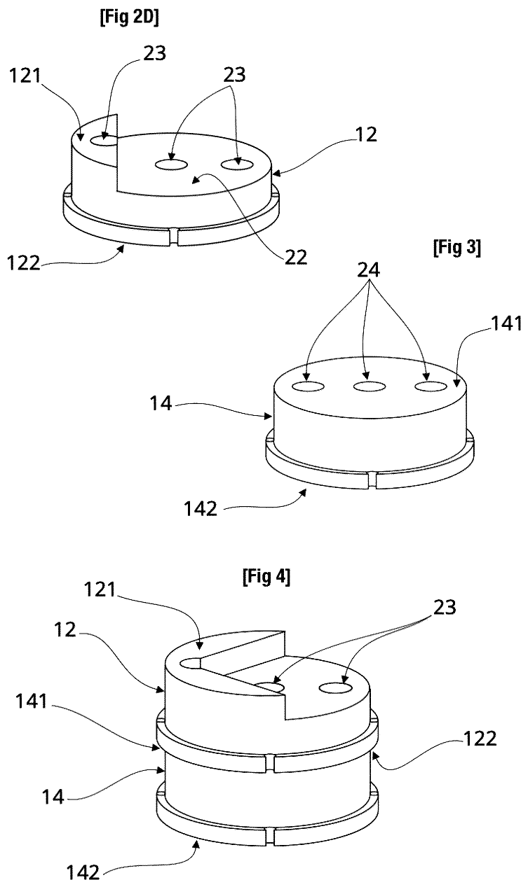

In this sense, as can be seen in more detail in FIGS. 2A, 2B, 2C and 2D, the drilling template 12 consists of a solid body element, comprising a recess 22 in a first surface 121 and three through holes 23 of the same diameter, preferably 8 mm, and equidistant from each other. The drilling template 12 further comprises a second flat and non-recessed surface 122, parallel to the first surface 121.

The function of the recess 22 on the first surface 121 of the drilling template 12 is to allow the user to drill holes in parts with different depths and in different positions, according to the construction and assembly project 13 of each object to be assembled and as will be described later. For this reason, there is a plurality of drilling templates 12 (FIGS. 2A, 2B, 2C and 2D), each comprising a recess 22 of different shape and depth, to suit different types of drilling for different types of construction and assembly project 13.

The base template 14, illustrated in FIG. 3, also consists of a solid body element, however, comprising a first base surface 141 that is flat and without recess and a second base surface 142 that is also flat and without recess, parallel opposite the first base surface 141. The base template 14 also comprises three through holes 24, of the same diameter, preferably 8 mm, and equidistant from each other.

The drilling template 12 and the base template 14 are cooperative with each other and with at least one construction and assembly project 13 for the assembly of at least one object 100. In this sense, as illustrated in FIG. 4, a drilling template 12 is positioned on a base template 14, so that the second surface 122 of the drilling template 12 rests on the first base surface 141 of the base template 14, positioning the three holes of the drilling template 12 aligned with the three holes of the base template 14.

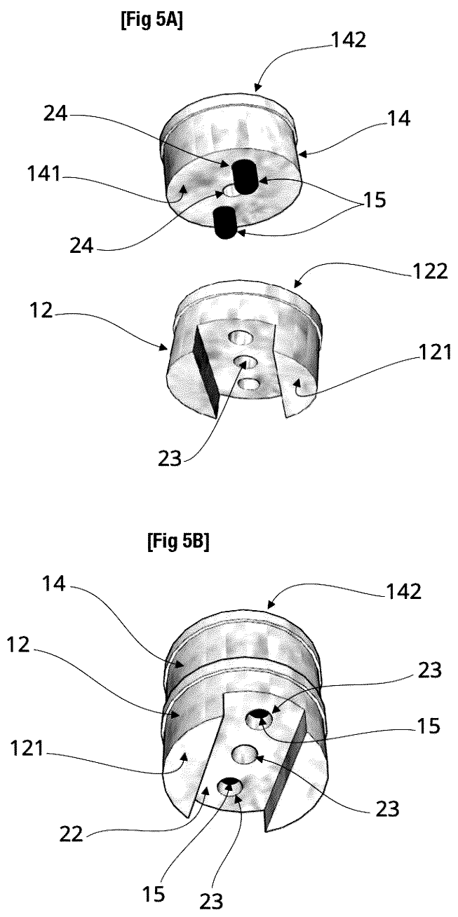

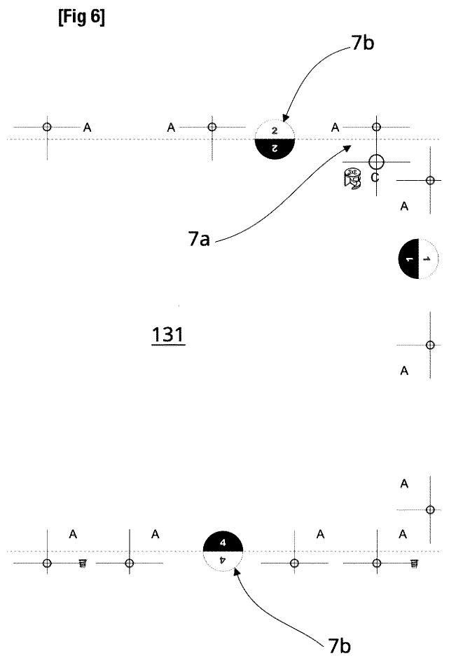

As can be seen in FIGS. 5A and 5B, the drilling template 12 and the base template 14 are kept cooperative with each other by means of a fixation made by a pair of dowels 15. The dowels 15 are inserted into the holes 24 of the base template 14, preferably the holes 24 positioned at the ends, leaving the central hole 24 free. These same dowels 15 are then inserted into the holes 23 of the drilling template 12, preferably in the holes 23 positioned at the ends, leaving the central hole 23 free, until the second surface 122 of the drilling template 12 rests on the first base surface 141 of the base template 14. As already mentioned, the holes 24 of the base template 14 and the holes 23 of the drilling template are aligned with each other.

Also, optionally, one of the pins 15 can be positioned in the central hole 24 while the other pin 15 is kept in one of the holes 24 at the end. This is done when it is necessary to use one of the holes 24 at the end for drilling, as in the case of the drilling template 12 illustrated in FIG. 2D, for example.

In this way, the functions of the holes positioned at the ends of the drilling template 12 and the base template 14 can be to receive the dowels 15, seating the first base surface 141 of the base template 14 to the second surface 122 of the drilling template 12, keep the drilling template 12 and the base template 14 joined and cooperating with each other, and also serving as a guide for the drilling tool.

The preferred function of the central hole 23 of the drilling template 12 and the central hole 24 of the base template 14 is to serve as a guide for the drilling tool, preferably a drill, used by the user to perform the necessary holes in the parts 17 of object 100, following the guidelines of the construction and assembly project 13, facilitating drilling according to the markings in the construction and assembly project 13, as will be described below. However, the central hole 23 may also receive one of the dowels 15 to keep the drilling template 12 and the base template 14 joined and cooperating with each other.

The construction and assembly project 13 is provided with a plurality of blades 131, on a 1:1 scale and preferably made of paper, to be positioned on the surfaces of a plurality of predefined parts 17 of at least one object 100 that you want to assemble. More specifically, and as can be seen in FIG. 6, the construction and assembly project 13 comprises at least one blade 131 for each part 17 of the object 100 and each of these blades 131 comprises information, markings and specifics for drilling and assembling the object 100.

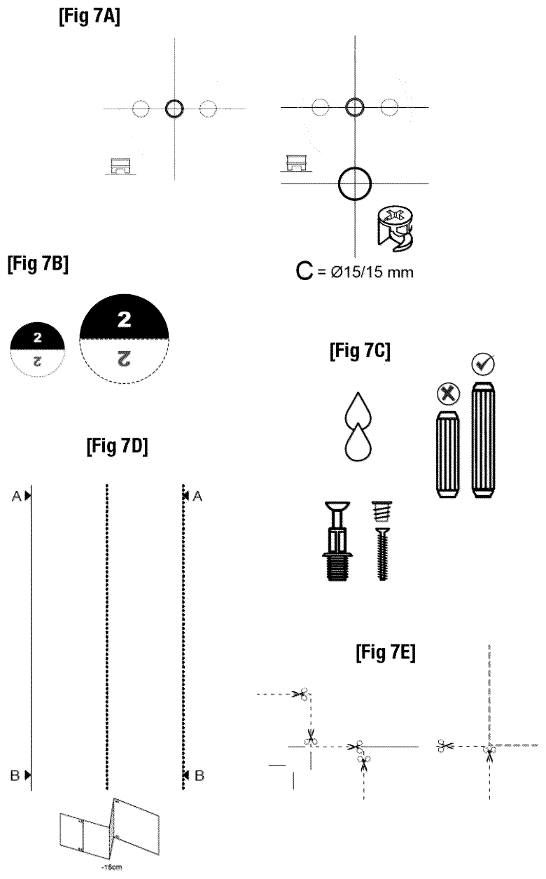

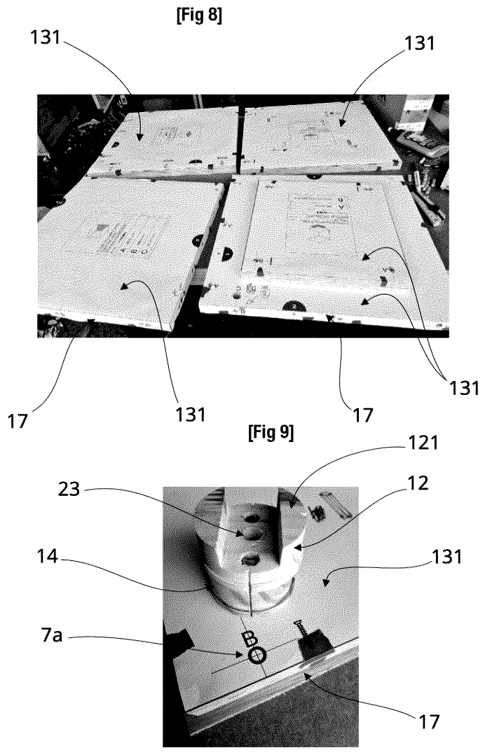

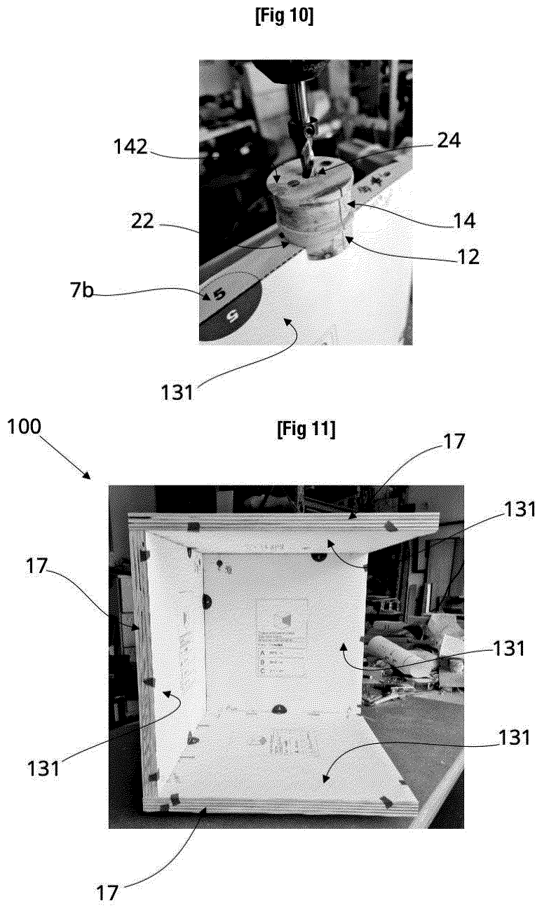

The information, markings and drilling and assembly specifics consist of legends of symbols and signs, such as the examples illustrated in FIGS. 7A, 7B, 7C, 7D and 7E. Each caption represents information to be followed by the user. In this sense, the legends illustrated in FIG. 7A identify the hole to be made and the positioning of the drilling templates 12 and base 14 to carry out this drilling, as well as the diameter of the hole and its depth. The legend illustrated in FIG. 7B identifies the edge number of part 17. The user needs to find the dark part label with the same number on another part 17 and position a dark label next to another dark part with the same number to form a circle. This step must follow the numerical order starting with caption number 1 onwards. Optionally, this legend may comprise a dark part that is arranged on the surface of the part 17 and a light part that must be folded on the line that joins them so that the light part of the legend is positioned on the plane of the thickness of the part 17 (FIGS. 8 and 10).

The legends illustrated in FIG. 7C identify the need to use glue, dowels or screws in the assembly process. The legends illustrated in FIG. 7D identify the parts of the blade 131 to be folded, while the legends illustrated in FIG. 7E identify the parts of the blade 131 to be cut. These labels are exemplary so that a plurality of distinct signs of these can be created and used according to the needs of each type of construction and assembly project 13 of each object assembly kit 10.

Thus, to use the object assembly kit 10, the user identifies the object assembly kit 10 of the object of interest. By removing the covers, which consist of the drilling template 12 and the base template 14 specific to the chosen object assembly kit 10, the user has access to the blades 131 of the construction and assembly project 13.

Based on the information contained in the blades 131, the user provides the parts 17 necessary to assemble the object 100 of interest. In this case, the user has the freedom to choose the type of material to be used and arrange for this material to be cut into the sizes specified in the construction and assembly project 13.

With the parts 17 cut to the specified sizes, the user fixes each blade 131 of the construction and assembly project 13 on the surface of a part 17, as illustrated in FIG. 8. Fixing the blades 131 on the surfaces of the parts 17 can be done with adhesive tape, glue or other suitable fixing material. Once the blade 131 is fixed to the surface of the part 17, the user must make the necessary bends indicated on the blade 131, so that the markings are also positioned in the thickness of each side of the part 17, as can also be seen in FIG. 8.

Once blade 131 is attached to part 17, the user will check the specifications of the necessary holes. In this case, as can be seen in FIG. 9, the blade 131 will indicate the hole to be made and the location of the templates to make the hole. The user then positions the drilling template 12 over the base template 14, keeping them fixed using the pins 15, as described above. In the case of drilling on the flat surface with the largest area of the part 17, the user positions the second base surface 142 of the base template 14 on the flat surface of the part 17, at the marking indicated on the blade 131 in accordance with the legend, leaving the first surface 121 of the drilling template 12 facing upwards. Using the central hole 23 of the drilling template 12 as a guide, the user inserts the cutting tool, preferably a drill, into the central hole 23, passing through the central hole 24 of the base template 14 until it touches the surface of the part 17 to perform the required drilling. This procedure is repeated on all surfaces of the parts 17 according to the markings on the blades 131.

When the construction and assembly project 13 indicates, on the blade 131, the need to drill a hole in the thickness of the part 17 as illustrated in FIG. 10, the user positions the first surface 121 of the drilling template 12 on the side of the part 17, so that the recess 22 on the first surface 121 of the drilling template 12 fits into the thickness of the part 17. In this way, the second base surface 142 of the base template 14 will face upwards. The user positions the set of templates at the marking indicated on the blade 131 and, inserting the drilling tool into the central hole 24 of the base template 14, passes through the central hole 23 of the drilling template 12 until it meets the surface of the side of the part 17, carrying out the necessary drilling. With this, the user who is not a professional in the field is able to drill holes with precision in the locations indicated on all sides of part 17, holes perpendicular in the various necessary positions and, in this way, guarantee precise and hassle-free assembly.

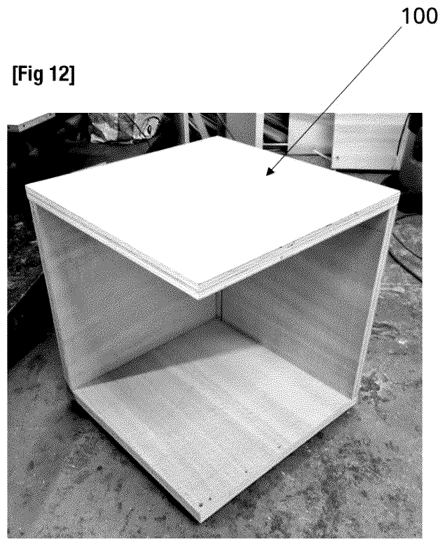

The user repeats the above procedures until all the necessary holes indicated on the blades 131 are made. Then, following the instructions in the other legends contained in the blades, the user assembles the pieces 17 together, resulting in the object 100 of interest, as can be seen in FIG. 11. The blades 131, fixed to the pieces 17 in a non-definitive manner, are then removed and the final object 100 is obtained in accordance with the construction and assembly project 13 of the object assembly kit 10 chosen (FIG. 12).

The object assembly kit 10 is offered to the user at a significantly lower price than currently known furniture kits or sets. This is because the processing of the parts to be packaged together with the fastening elements in the already known ready-to-assemble furniture kits or sets is expensive and, in the case of the object assembly kit 10 in question, the user will provide the parts and fastening elements according to their interest and budget. In other words, the user chooses whether to purchase noble or simpler wood or materials to build the object of interest. Likewise, the user chooses the type of finish they will give to the object once assembled. All this in a simple and safe way.

In this way, the object assembly kit 10 encourages and facilitates the user to learn and undertake larger and more elaborate projects, but which are indicated in a simplified way on the blades 131 of each construction and assembly project 13 so as to be within the reach of anyone's constructive capacity.

Having described an example of preferred embodiment, it must be understood that the scope of the present invention covers other possible variations, being limited only by the content of the attached claim, including possible equivalents.

What is claimed is:

1. An object assembly kit comprising:
a hollow body provided with lids;
at least one construction and assembly project inserted in the hollow body, said construction and assembly project being provided with a plurality of blades to be positioned on surfaces of a plurality of pre-defined parts of at least one object, the plurality of blades comprising information, markings and assembly specifics of at least one object;
wherein the lids consist of at least one drilling template fitted to a first end of the hollow body and at least one base template fitted to a second end of the hollow body, enclosing the at least one construction and assembly project in the hollow body; and
wherein the drilling template and the base template are cooperative with each other and with the at least one construction and assembly project for the assembly of the at least one object.
